(19) United States
(12) Patent Application Publication
(10) Pub. No.: US 2022/0126851 A1
(43) Pub. Date: Apr. 28, 2022

(54) NEUTRAL STABILITY PATH FOLLOWING UNDER DRIVER-APPLIED STEERING TORQUE

(71) Applicant: GM Global Technology Operations LLC, Detroit, MI (US)

(72) Inventors: Jimmy Zhong Yan Lu, Markham (CA); Mohammadali Shahriari, Markham (CA); Reza Zarringhalam, Whitby (CA)

(21) Appl. No.: 17/078,359

(22) Filed: Oct. 23, 2020

(51) Int. Cl. B60W 50/12; G05D 1/02; B60W 60/00

(52) U.S. Cl. CPC B60W 50/12; B60W 2540/18; B60W 60/005; G05D 1/0212

(57) ABSTRACT

An autonomous vehicle and a system and method of operating the autonomous vehicle. The system includes a processor. A driver-applied steering torque is received at the autonomous vehicle while the autonomous vehicle is following an initial target path via a path tracking program. The processor receives the driver-applied steering torque and allows a driver to adjust a path of the autonomous vehicle from the initial target path to a final target path determined through the driver-applied steering torque.

### INTRODUCTION

The subject disclosure relates to autonomous or semi-autonomous vehicles and, in particular, to systems and methods for adjusting a path trajectory tracked by an autonomous or semi-autonomous vehicle.

An autonomous or semi-autonomous vehicle can include a driver-assisted driving mode of automation in which the vehicle operates on its own with occasional steering inputs from the driver. The autonomous steering feature operates a path tracking program to follow a target path along a road without any input from the driver. To assume control over the vehicle, the driver can apply a torque to the steering wheel to override and temporarily disengage the path tracking program. However, the driver does not have the ability to adjust the location of the target path without assuming control of the vehicle. The path tracking program therefore resists any steering input or torque applied by the driver to maintain its tracking of the current target path. Accordingly, it is desirable to provide a system and method for allowing the driver to adjust a target path without assuming control of the vehicle and without resistance from the vehicle.

### SUMMARY

In one exemplary embodiment, a method of operating an autonomous vehicle is disclosed. A driver-applied steering torque is received at the autonomous vehicle while the autonomous vehicle is following an initial target path via a path tracking program. A driver is allowed to adjust a path of the autonomous vehicle from the initial target path to a final target path determined through the driver-applied steering torque.

In addition to one or more of the features described herein, the driver-applied steering torque is greater than an activation threshold and less than an override threshold for disengaging the path tracking program. The method further includes maintaining via the path tracking program, the path of the autonomous vehicle at the final target path when the driver-applied steering torque is removed. The driver experiences a variable resistance for manual steering while adjusting the path of the autonomous vehicle with the path tracking program engaged. The method further includes generating a dynamic path that lags a lateral position of the autonomous vehicle based on the driver-applied steering torque and vehicle dynamics. The method further includes tracking the autonomous vehicle to the dynamic path to provide an artificial damping resistance to a lateral motion of the autonomous vehicle. The method further includes adjusting the artificial damping resistance of the autonomous vehicle to accommodate for hardware differences and driver habits.

In another exemplary embodiment, a system for operating an autonomous vehicle is disclosed. The system includes a processor configured to receive a driver-applied steering torque while the autonomous vehicle is following an initial target path via a path tracking program, and allow a driver to adjust a path of the autonomous vehicle from the initial target path to a final target path determined through the driver-applied steering torque.

In addition to one or more of the features described herein, the driver-applied steering torque is greater than an activation threshold and less than an override threshold for disengaging the path tracking program. The processor is further configured to maintain the path of the autonomous vehicle at the final target path when the driver-applied steering torque is removed. The processor is further configured to allow the driver to experience a variable resistance for manual steering while the driver adjusts the path of the autonomous vehicle with the path tracking program engaged. The processor is further configured to generate a dynamic path that lags a lateral position of the autonomous vehicle based on the driver-applied steering torque and vehicle dynamics. The processor is further configured to track the autonomous vehicle to the dynamic path to provide an artificial damping resistance to a lateral motion of the autonomous vehicle. The processor is further configured to adjust the artificial damping resistance of the autonomous vehicle to accommodate for hardware differences and driver habits.

In yet another exemplary embodiment, an autonomous vehicle is disclosed. The autonomous vehicle includes a processor configured to receive a driver-applied steering torque while the autonomous vehicle is following an initial target path via a path tracking program, and allow a driver to adjust a path of the autonomous vehicle from the initial target path to a final target path determined through the driver-applied steering torque.

In addition to one or more of the features described herein, the driver-applied steering torque is greater than an activation threshold and a less than an override threshold for disengaging the path tracking program. The processor is further configured to maintain the path of the autonomous vehicle at the final target path when the driver-applied steering torque is removed. The processor is further configured to allow the driver to experience a variable resistance for manual steering while the driver adjusts the path of the autonomous vehicle with the path tracking program engaged. The processor is further configured to generate a dynamic path that lags a lateral position of the autonomous vehicle based on the driver-applied steering torque and vehicle dynamics. The processor is further configured to track the autonomous vehicle to the dynamic path to provide an artificial damping resistance to a lateral motion of the autonomous vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle in an illustrative embodiment;

FIG. 2 shows a top view of a roadway illustrating an effect of the method disclosed herein in allowing a driver to select a target path;

FIG. 3 shows a top view of the roadway illustrating operation of the path tracking program in a lane changing procedure;

FIG. 4 shows the autonomous vehicle traveling along a final target path with driver torque removed;

FIG. 5 shows various graphs illustrating the effect of the driver-applied steering torque on the autonomous vehicle without using the methods disclosed herein; and

FIG. 6 shows various graphs illustrating the effect of the driver-applied steering torque on the autonomous vehicle using the methods disclosed herein.

### DETAILED DESCRIPTION

The following description is merely exemplary in nature and is not intended to limit the present disclosure, its application or uses. It should be understood that throughout the drawings, corresponding reference numerals indicate like or corresponding parts and features.

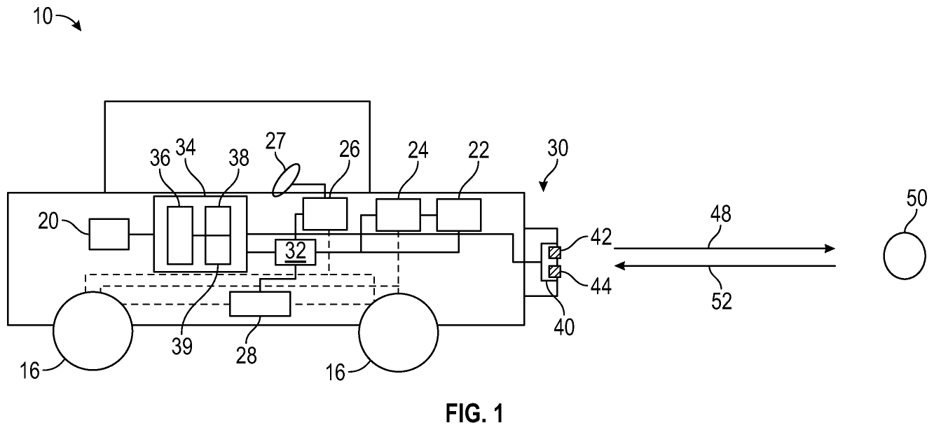

In accordance with an exemplary embodiment, FIG. 1 shows an autonomous vehicle 10. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. It is to be understood that the system and methods disclosed herein can also be used with an autonomous vehicle operating at any of the levels One through Five. In various embodiments, the autonomous vehicle 10 is an active-safety assisted driving vehicle.

The autonomous vehicle 10 generally includes at least a navigation system 20, a propulsion system 22, a transmission system 24, a steering system 26, a brake system 28, a sensor system 30, an actuator system 32, and a controller 34. The navigation system 20 determines a road-level route plan for automated driving of the autonomous vehicle 10. The propulsion system 22 provides power for creating a motive force for the autonomous vehicle 10 and can, in various embodiments, include an internal combustion engine, an electric machine such as a traction motor, and/or a fuel cell propulsion system. The transmission system 24 is configured to transmit power from the propulsion system 22 to two or more wheels 16 of the autonomous vehicle 10 according to selectable speed ratios. The steering system 26 influences a position of the two or more wheels 16. The brake system 28 is configured to provide braking torque to the two or more wheels 16.

The sensor system 30 includes a radar system 40 that senses objects in an exterior environment of the autonomous vehicle 10 and provides various parameters of the objects useful in locating the position and relative velocities of various remote vehicles in the environment of the autonomous vehicle. Such parameters can be provided to the controller 34. In operation, the transmitter 42 of the radar system 40 sends out a radio frequency (RF) reference signal 48 that is reflected back at the autonomous vehicle 10 by one or more objects 50 in the field of view of the radar system 40 as one or more reflected echo signals 52, which are received at receiver 44. The one or more reflected echo signals 52 can be used to determine various parameters of the one or more objects 50, such as a range of the object, Doppler frequency or relative radial velocity of the object, and azimuth, etc. The sensor system 30 includes additional sensors, such as digital cameras, for identifying road features, etc.

The controller 34 builds a trajectory for the autonomous vehicle 10 based on the output of sensor system 30. The controller 34 can provide the trajectory to the actuator system 32 to control the propulsion system 22, transmission system 24, steering system 26, and/or brake system 28 in order to navigate the autonomous vehicle 10 with respect to the one or more objects 50. The controller 34 includes a processor 36 and a computer readable storage device or computer-readable storage medium 38. The computer readable storage medium includes programs or instructions 39 that, when executed by the processor 36, operate the autonomous vehicle based on sensor system outputs. The computer-readable storage medium 38 may further include programs or instructions 39 that when executed by the processor 36, to perform the various methods disclosed herein.

The controller 34 can operate a path tracking program that tracks a lateral position of the autonomous vehicle 10 with respect to a lane center of a road and controls the lateral position to move the autonomous vehicle 10 along a selected target path of the road. The path tracking program tracks any lateral deviation of the autonomous vehicle 10 from the target path and makes a correction when the deviation exceeds a realignment threshold to maintain the lateral position of the target path.

In various embodiments, a method is disclosed herein allowing a driver to intervene in the path tracking program in order to change a target path or lateral position of the autonomous vehicle 10 with respect to a desired path. The path tracking program receives a driver-applied steering torque at the steering wheel 27. When the driver-applied steering torque is greater than an activation threshold and less than an override torque, the path tracking program accommodates the driver by dynamically offsetting the target path. The driver thereby repositions the vehicle using the steering wheel 27, similar to normal hands-on driving. When the driver-applied steering torque is removed, the path tracking program tracks to the target path to which the vehicle has been repositioned.

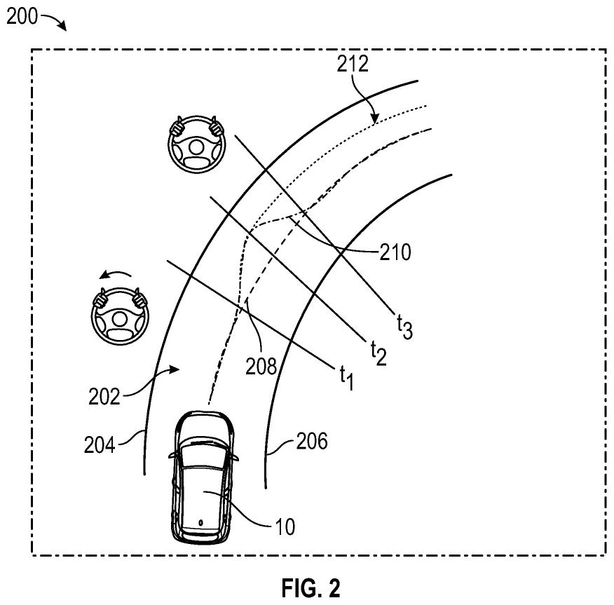

FIG. 2 shows a top view 200 of a roadway 202 illustrating an effect of the method disclosed herein in allowing a driver to select a target path. Autonomous vehicle 10 is shown traveling along roadway 202. The roadway includes a left edge 204, right edge 206 and lane center 208 lying halfway between the left edge and right edge. The roadway 202 curves to the right in the direction of travel of the autonomous vehicle 10. Time marking t₁, t₂ and t₃ define various regions of driver-applied steering torque at the steering wheel 27 of the autonomous vehicle 10. Prior to time t₁, the autonomous vehicle 10 tracks its trajectory to a target path at the lane center 208. Between time t₁ and time t₂, the driver applies a torque at the steering wheel in order to move the autonomous vehicle 10 to a lateral position outside of the curve. Between time t₂ and t₃, the driver's torque is removed. Using conventional tracking, the driver-applied steering torque is resisted at all times in order to maintain the autonomous vehicle 10 along the lane center 208. Therefore, between time t₂ and t₃, the autonomous vehicle 10 travels along an initial vehicle path 210 to return from the lateral position reached at time t₂ back to the lane center 208.

Using the methods disclosed herein, the path tracking program allows the driver to select the lateral position via the driver-applied steering torque. The driver is able to reposition the vehicle laterally between times t₁ and t₂ with an artificial damping resistance provided from the path tracking program. After time t₂, the path tracking program disclosed herein allows the vehicle 10 to travel along a second vehicle path 212 to remain at the lateral position of time t₂. The path tracking program is engaged and in control throughout the maneuver.

Table 1 below shows various ranges of driver-applied steering torque, τ_{d}, and their effects on the autonomous vehicle.

TABLE 1

| | Effect of driver-applied |
|---|---|
| Range of driver-applied steering torque | steering torque on vehicle |
| 0 ≤ \| τ_{d} \| < τ_{activation} | No effect |
| τ_{activation} ≤ \| τ_{d} \| < τ_{override} | Activate lane change |
| τ_{override} ≤ \| τ_{d} \| | Drive assumes control of vehicle |

The path tracking program tracks a driver-applied steering torque |τ_{d}| against threshold values τ_{activation} and τ_{override}. When the driver-applied steering torque is less that the activation threshold τ_{activation}, then the path tracking program maintains a current offset of the target path and resists the driver-applied steering torque to maintain its trajectory. When the driver-applied steering torque is greater than the activation threshold and less than the override threshold τ_{override}, then the path tracking program dynamically offsets the target path along the direction of the driver-applied steering torque, allowing the driver to reposition or move the vehicle laterally along the roadway. The driver is thereby able to adjust the path of the vehicle through manual steering at the steering wheel, with the driver experiencing a variable resistance imparted by the artificial damping from the controller torque. When the driver-applied steering torque is greater than the override threshold, then a signal is sent to the path tracking program to allow the driver to assume control of the vehicle and the path tracking program is disengaged.

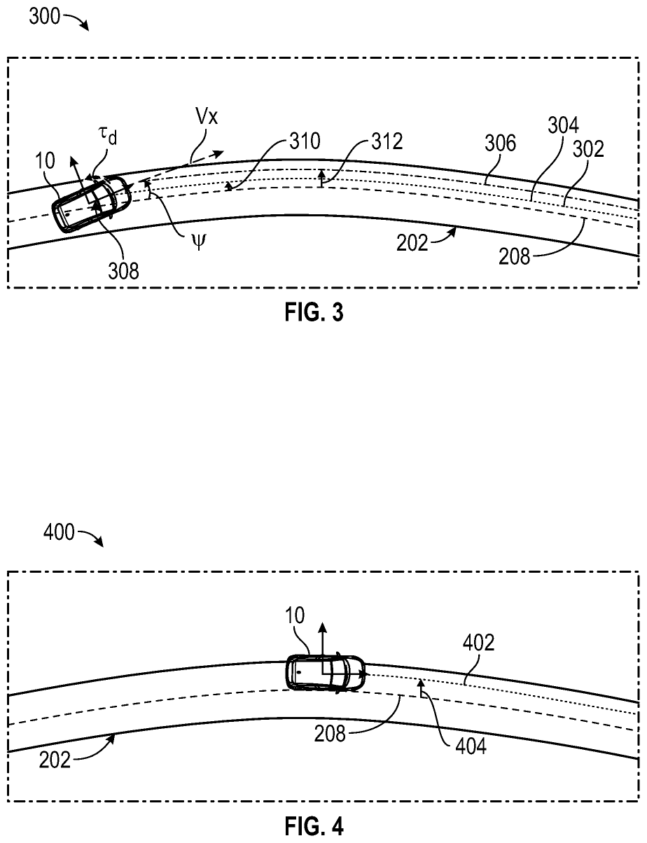

FIG. 3 shows a top view 300 of the roadway 202 illustrating operation of the path tracking program in a lane changing procedure. The autonomous vehicle 10 is shown traveling along an initial target path 302. The autonomous vehicle 10 assigns a target path 304 to the initial target path 302 and follows the target path 304. A vehicle-centered coordinate system 308 is shown having an x-axis extending along a longitudinal axis of the vehicle and a y-axis extending along a lateral axis of the autonomous vehicle 10. A forward speed vₓ of the vehicle is shown along the x-axis. An angle between the x-axis and the target path 304 is indicated by a relative heading angle ψ. The lane center 208 can be parametrized in the vehicle-centered coordinate system 308 as shown in Eq. (1):

y_{c}=c₀+c₁x+c₂x²+ . . . Eq. (1)

where y_{c} is a lateral coordinate of the lane center 208 within the road, x is a longitudinal coordinate along the road, c₀ is an offset of the lane center, c₁ is a heading of the lane center, and c₂ is a second polynomial coefficient of the lane center. A target path offset 310 between the target path 304 and the lane center 208 is calculated as shown in Eq. (2):

y_{target}=y_{c}−y_{target} Eq. (2)

The curvature of the lane center 208 is related to the second polynomial coefficient c₂, as shown in Eq. (3):

κ_{c}≈−2c₂ Eq. (3)

The relative heading angle ψ is given by Eq. (4):

ψ≈−c₁ Eq. (4)

The path tracking program maintains the autonomous vehicle 10 along the initial target path 302 by enforcing a stiffness condition and a positive damping condition to resist lateral deviations. The stiffness condition, which provides neutral stability for lane offset with respect to driver-applied steering torque, is given in Eq. (5):

$$\frac{\partial {y}_{c}}{\partial {τ}_{d}} = 0 \qquad Eq . ( 5 )$$

where τ_{d} is a driver-applied steering torque on the autonomous vehicle 10. Eq. (5) indicates that the location of the lane center in the vehicle-centered coordinate system 308 does not change as the driver applies a torque on the vehicle. The amount of driver torque required to maintain the offset position is zero when the stiffness condition is enforced. The positive damping condition is given in Eq. (6):

$$\frac{\partial {\dot{y}}_{c}}{\partial {τ}_{d}} > 0 \qquad Eq . ( 6 )$$

The positive damping condition can be adjusted prior to vehicle operations to accommodate different driving conditions, vehicle programs, hardware differences and driver habits.

FIG. 3 also shows a preview path 306 resulting from the driver-applied steering torque. The preview path 306 is a dynamic path that is predicted for the autonomous vehicle 10 based on vehicle dynamics, such as location, velocity, heading angle, etc. The preview path 306 is parametrized with respect to the lane center 208 by a preview offset 312 (Δy_{preview}). The path tracking program predicts the preview path 306 and target path 304 at a selected time in the future. The preview path is determined by the driver-applied steering torque. While the driver is applying the torque, the path tracking program checks for differences between the preview path and the target path and adjusts the target path appropriately by adjusting the target path in tandem with the preview path, as discussed below with respect to Eqs. (7)-(10).

The path tracking program predicts a future path by tracking various parameters over a discrete timeline that is segmented into a series of time steps separated by a constant step interval Δtₛ. If the driver-applied steering torque is present (i.e., |τ_{d}|≥τ_{override}) and below override threshold, and the vehicle is translating in the same direction as the steering torque (i.e., sgn(τ_{d})==sgn(ψ), then a lane adjusting program can be activated to select a new target path.

The preview path relative to the lane center at current time step is used to generate a path that leads the current position of the vehicle, as shown in Eq. (7):

Δy_{preview}_{ₖ}=c₀+ψVₓΔt_{LA}+½VₓΔt_{LA}²(\dot{ψ}+κ_{c}Vₓ) Eq. (7)

where Δy_{preview}_{ₖ} is the preview offset at a k^{th} time step, Δt_{LA} is a lead time for anticipating a lane position and κ_{c} is the curvature of the lane center 208 from Eq. (3). The target path at the k^{th} time step is based on the target path at a (k−1)^{th} time step, as shown in Eq. (8):

Δy_{target}_{ₖ}=Δy_{target}_{ₖ₋₁}+K_{damping}⁻¹ψVₓΔtₛ Eq. (8)

where K_{damping} is a damping resistance to a lane change. The target path as constructed lags the current position of the vehicle and thus positively resists or provides artificial damping against the driver-applied steering torque as the target path follows the preview path. The target path offset is bounded by minimum and maximum offsets, shown in Eq. (9):

Δyₘᵢₙ≤|Δy_{target}_{ₖ}|≤Δyₘₐₓ Eq. (9)

and the target offset is confined to be less than the preview offset, as shown in Eq. (10):

|Δy_{target}_{ₖ}|≤|Δy_{preview}_{ₖ}| Eq. (10)

The damping resistance prevents the vehicle from overshooting the preview path. Once the driver-applied steering torque is removed, the target path is set to the preview path as shown in Eq. (11)

Δy_{target}_{ₖ}≤Δy_{preview}_{ₖ₋₁} Eq. (11)

FIG. 4 shows a top view 400 of the roadway 202 illustrating operation of the autonomous vehicle 10 traveling along a final target path 402 with driver torque removed. The final target path 402 is aligned with the preview path 306. The offset 404 of the final target path 402 is shown.

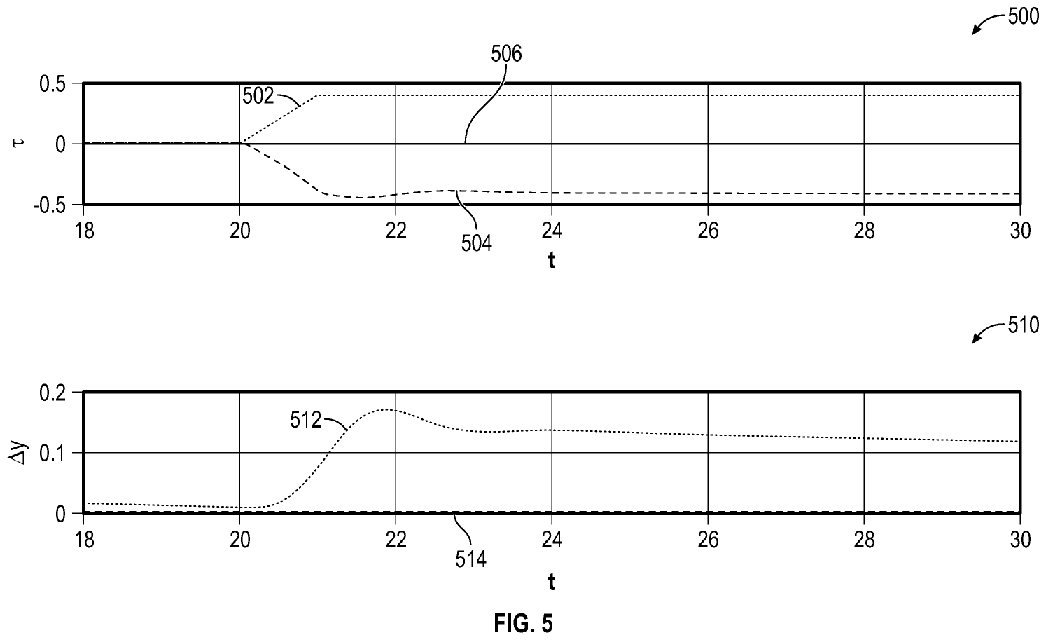

FIG. 5 shows various graphs illustrating the effect of the driver-applied steering torque on the autonomous vehicle 10 without using the methods disclosed herein. Graph 500 shows various torques applied to the vehicle. Time is shown along the abscissa in seconds and torque is shown in Newton-meters along the ordinate axis. Curve 502 shows the driver-applied steering torque from the driver. Curve 504 shows a control torque applied by the autonomous vehicle 10 in response to the driver-applied steering torque from the driver. As shown by curve 502, from about time t=20 seconds to about time t=21 seconds, the driver increases a driver torque τ_{d} to the vehicle, the driver maintains the driver-applied steering torque after t=21 seconds. As shown by curve 504, the autonomous vehicle 10 applies a control torque that acts against the driver-applied steering torque. As a result, a disturbance torque 506 on the vehicle is zero over time.

Graph 510 shows the target path and preview path for the vehicle in response to the driver applied steering torque. Time is shown along the abscissa in seconds and lateral offset is shown in meters along the ordinate axis. The preview path 514 is shown to be set along the lane center, with little or no offset. While the offset of the target path 512 is shown to increase at time=20 seconds due to the introduction of the driver-applied steering torque at that time, the preview path 514 remains unchanged. Thus, the offset of the target path 512 is due only to the presence of the driver-applied steering torque and will return to tracking the preview path 514 once the driver-applied steering torque is removed.

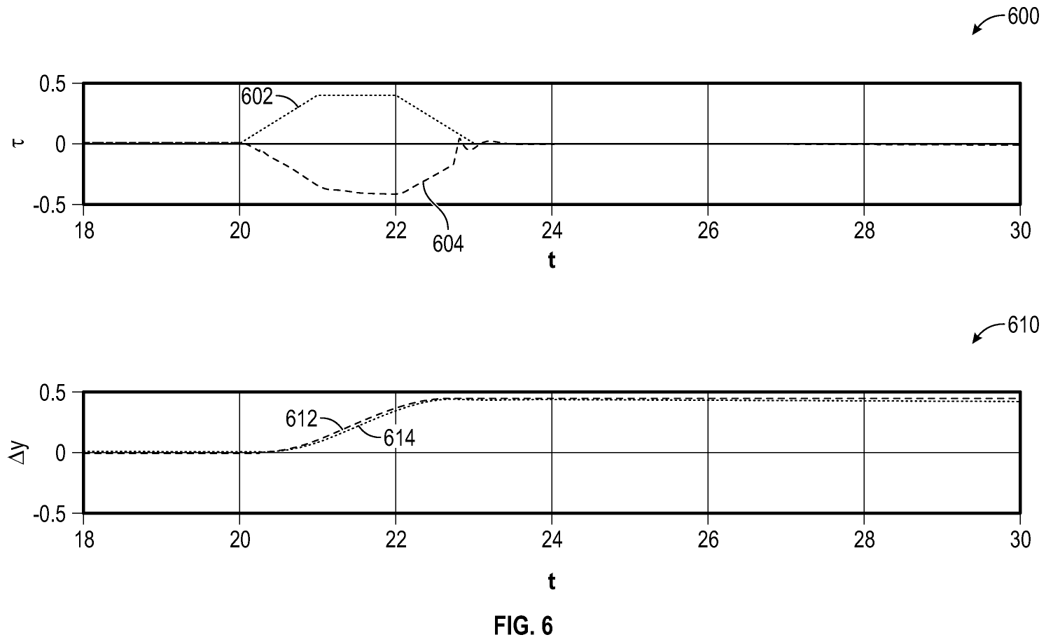

FIG. 6 shows various graphs illustrating the effect of the driver-applied steering torque on the autonomous vehicle 10 using the methods disclosed herein. Graph 600 shows various torques applied to the vehicle. Time is shown along the abscissa in seconds and torque is shown in Newton-meters along the ordinate axis. Curve 602 shows the driver-applied steering torque from the driver. Curve 604 shows a control torque applied by the autonomous vehicle 10. From time t=20 seconds to about time t=21 seconds, the driver increases a driver-applied steering torque τ_{d} (curve 602) to the vehicle. From time t=21 seconds to about time t=22 seconds, the driver-applied steering torque is held constant. From time t=22 seconds to about time t=23, the driver-applied steering torque is removed. The autonomous vehicle 10 applies the control torque (curve 604) against the driver-applied steering torque during this time interval to provide damping effect against the driver-applied steering torque.

Graph 610 shows the target path and preview path for the vehicle in response to the driver applied steering torque. Time is shown along the abscissa in seconds and lateral offset is shown in meters along the ordinate axis. The vehicle offset 614 is shown being adjusted from an initial target path before time t=20 seconds to a final target path after time t=23. A curve 612 representing the preview path 306 moves slightly ahead of the vehicle offset while the driver-applied steering torque is present to move the vehicle to the final target path. The vehicle tracks the final target path without any driver-applied steering torque after time t=23.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating an autonomous vehicle, comprising:
receiving a driver-applied steering torque at the autonomous vehicle while the autonomous vehicle is following an initial target path via a path tracking program; and
allowing a driver to adjust a path of the autonomous vehicle from the initial target path to a final target path determined through the driver-applied steering torque.

2. The method of claim 1, wherein the driver-applied steering torque is greater than an activation threshold and less than an override threshold for disengaging the path tracking program.

3. The method of claim 1, further comprising maintaining via the path tracking program, the path of the autonomous vehicle at the final target path when the driver-applied steering torque is removed.

4. The method of claim 1, wherein the driver experiences a variable resistance for manual steering while adjusting the path of the autonomous vehicle with the path tracking program engaged.

5. The method of claim 1, further comprising generating a dynamic path that lags a lateral position of the autonomous vehicle based on the driver-applied steering torque and vehicle dynamics.

6. The method of claim 5, further comprising tracking the autonomous vehicle to the dynamic path to provide an artificial damping resistance to a lateral motion of the autonomous vehicle.

7. The method of claim 6, further comprising adjusting the artificial damping resistance of the autonomous vehicle to accommodate for hardware differences and driver habits.

8. A system for operating an autonomous vehicle, comprising:
a processor configured to:
receive a driver-applied steering torque while the autonomous vehicle is following an initial target path via a path tracking program; and
allow a driver to adjust a path of the autonomous vehicle from the initial target path to a final target path determined through the driver-applied steering torque.

9. The system of claim 8, wherein the driver-applied steering torque is greater than an activation threshold and less than an override threshold for disengaging the path tracking program.

10. The system of claim 8, wherein the processor is further configured to maintain the path of the autonomous vehicle at the final target path when the driver-applied steering torque is removed.

11. The system of claim 8, wherein the processor is further configured to allow the driver to experience a variable resistance for manual steering while the driver adjusts the path of the autonomous vehicle with the path tracking program engaged.

12. The system of claim 8, wherein the processor is further configured to generate a dynamic path that lags a lateral position of the autonomous vehicle based on the driver-applied steering torque and vehicle dynamics.

13. The system of claim 12, wherein the processor is further configured to track the autonomous vehicle to the dynamic path to provide an artificial damping resistance to a lateral motion of the autonomous vehicle.

14. The system of claim 13, wherein the processor is further configured to adjust the artificial damping resistance of the autonomous vehicle to accommodate for hardware differences and driver habits.

15. An autonomous vehicle, comprising:
a processor configured to:
receive a driver-applied steering torque while the autonomous vehicle is following an initial target path via a path tracking program; and
allow a driver to adjust a path of the autonomous vehicle from the initial target path to a final target path determined through the driver-applied steering torque.

16. The autonomous vehicle of claim 15, wherein the driver-applied steering torque is greater than an activation threshold and a less than an override threshold for disengaging the path tracking program.

17. The autonomous vehicle of claim 15, wherein the processor is further configured to maintain the path of the autonomous vehicle at the final target path when the driver-applied steering torque is removed.

18. The autonomous vehicle of claim 15, wherein the processor is further configured to allow the driver to experience a variable resistance for manual steering while the driver adjusts the path of the autonomous vehicle with the path tracking program engaged.

19. The autonomous vehicle of claim 15, wherein the processor is further configured to generate a dynamic path that lags a lateral position of the autonomous vehicle based on the driver-applied steering torque and vehicle dynamics.

20. The autonomous vehicle of claim 19, wherein the processor is further configured to track the autonomous vehicle to the dynamic path to provide an artificial damping resistance to a lateral motion of the autonomous vehicle.
